(19) United States
(12) Patent Application Publication
(10) Pub. No.: US 2019/0106651 A1
(43) Pub. Date: Apr. 11, 2019

(54) PASSENGER CAR LUBRICATING OIL COMPOSITIONS FOR FUEL ECONOMY

(71) Applicants: Chevron Japan Ltd., San Ramon, CA (US); Chevron Oronite Company LLC, San Ramon, CA (US)

(72) Inventors: Koichi Kubo, Yokohama-shi (JP); Yoshitaka Takeuchi, Haibarg-gun (JP); Masaya Kanauchi, Makinohara-shi (JP); Chihiro Sone, Makinohari-shi (JP); Yat Fan Suen, Martinez, CA (US); Trevor W. Miller, Pleasant Hill, CA (US)

(21) Appl. No.: 15/726,652

(22) Filed: Oct. 6, 2017

(51) Int. Cl. C10M 169/04; C10M 133/16; C10M 133/44; C10M 129/68; C10M 129/54; C10M 135/10; C10M 137/10; C10M 129/10; C10M 133/12; C10M 125/26; F02M 37/22

(52) U.S. Cl. CPC C10M 169/04; C10M 2203/1006; C10M 133/44; C10M 129/68; C10M 129/54; C10M 135/10; C10M 137/10; C10M 129/10; C10M 133/12; C10M 125/26; F02M 37/22; C10M 2201/087; C10M 2215/06; C10M 2207/023; C10M 2223/045; C10M 2219/046; C10M 2207/262; C10M 2207/28; C10M 2215/223; C10M 2215/08; C10N 2240/102; C10N 2240/104; C10N 2230/04; C10N 2230/10; C10N 2230/18; C10M 133/16

(57) ABSTRACT

The present disclosure generally relates to an internal combustion engine lubricating oil composition comprising: (a) a major amount of a base oil of lubricating viscosity; (b) a nitrogen-containing dispersant; (c) an alkaline earth metal containing detergent; (d) a compound comprising the reaction product of: (i) a nitrogen-containing reactant, wherein the nitrogen-containing reactant comprises an alkyl alkanolamide, an alkyl alkoxylated alkanolamide, an alkyl alkanolamine, an alkyl alkoxylated alkanolamine or mixtures thereof, (ii) a source of boron, and (iii) a hydrocarbyl polyol, having at least three hydroxyl groups.

Also provided is a method for improving fresh oil or used oil fuel economy in an internal combustion engine comprising lubricating said engine with said lubricating oil composition.

### BACKGROUND OF THE DISCLOSURE

The boundary friction regime is an important consideration in the design of low viscosity engine oils. Boundary friction occurs when the fluid film separating two surfaces becomes thinner than the height of asperities on the surfaces. The resulting surface to surface contact creates undesirable high friction and poor fuel economy in an engine. Boundary friction in an engine can occur under high loads, low engine speeds and at low oil viscosities. Low viscosity engine oils make the engine more susceptible to operating in boundary friction conditions due to the oil's thinner, less robust film. Because additives—not base oil—influence the coefficient of friction under boundary conditions, additives that demonstrate lower coefficients of friction under boundary conditions will give superior fuel economy in a low viscosity oil in an engine.

Despite advances in lubricant oil formulation technology, there exists a need for a low viscosity engine oil lubricant suitable for both hybrid vehicles and direct injection engines that effectively improves fuel economy while maintaining or improving friction reduction properties and deposit control.

The present disclosure generally relates to low viscosity heavy-duty and passenger car lubricating oil compositions (i.e., SAE viscosity grade of 0W or 5W and an HTHS viscosity of less than 2.9 cP) containing an organic friction modifier that show surprisingly good frictional characteristics and improved fuel economy, compared to some more commonly known friction modifiers in the art.

### SUMMARY OF THE DISCLOSURE

In accordance with one embodiment of the present disclosure, there is provided an internal combustion engine lubricating oil composition comprising: (a) a major amount of a base oil of lubricating viscosity; (b) a nitrogen-containing dispersant; (c) an alkaline earth metal containing detergent; (d) a compound comprising the reaction product of: (i) a nitrogen-containing reactant, wherein the nitrogen-containing reactant comprises an alkyl alkanolamide, an alkyl alkoxylated alkanolamide, an alkyl alkanolamine, an alkyl alkoxylated alkanolamine or mixtures thereof, (ii) a source of boron, and (iii) a hydrocarbyl polyol, having at least three hydroxyl groups.

Also provided is a method for improving fresh oil or used oil fuel economy in an internal combustion engine comprising lubricating said engine with said lubricating oil composition.

### DETAILED DESCRIPTION OF THE DISCLOSURE

To facilitate the understanding of the subject matter disclosed herein, a number of terms, abbreviations or other shorthand as used herein are defined below. Any term, abbreviation or shorthand not defined is understood to have the ordinary meaning used by a skilled artisan contemporaneous with the submission of this application.

### Definitions:

In this specification, the following words and expressions, if and when used, have the meanings given below.

A “major amount” means in excess of 50 weight % of a composition.

A “minor amount” means less than 50 weight % of a composition, expressed in respect of the stated additive and in respect of the total mass of all the additives present in the composition, reckoned as active ingredient of the additive or additives.

“Active ingredients” or “actives” refers to additive material that is not diluent or solvent.

All percentages reported are weight % on an active ingredient basis (i.e., without regard to carrier or diluent oil) unless otherwise stated.

The abbreviation “ppm” means parts per million by weight, based on the total weight of the lubricating oil composition.

High temperature high shear (HTHS) viscosity at 150° C. was determined in accordance with ASTM D4683.

Kinematic viscosity at 100° C. (KV₁₀₀) was determined in accordance with ASTM D445.

Metal—The term “metal” refers to alkali metals, alkaline earth metals, or mixtures thereof.

Throughout the specification and claims the expression oil soluble or dispersible is used. By oil soluble or dispersible is meant that an amount needed to provide the desired level of activity or performance can be incorporated by being dissolved, dispersed or suspended in an oil of lubricating viscosity. Usually, this means that at least about 0.001% by weight of the material can be incorporated in a lubricating oil composition. For a further discussion of the terms oil soluble and dispersible, particularly “stably dispersible”, see U.S. Pat. No. 4,320,019 which is expressly incorporated herein by reference for relevant teachings in this regard.

The term “sulfated ash” as used herein refers to the non-combustible residue resulting from detergents and metallic additives in lubricating oil. Sulfated ash may be determined using ASTM Test D874.

The term “Total Base Number” or “TBN” as used herein refers to the amount of base equivalent to milligrams of KOH in one gram of sample. Thus, higher TBN numbers reflect more alkaline products, and therefore a greater alkalinity. TBN was determined using ASTM D 2896 test.

Unless otherwise specified, all percentages are in weight percent.

In general, the level of sulfur in the lubricating oil compositions of the present invention is less than or equal to about 0.7 wt. %, based on the total weight of the lubricating oil composition, e.g., a level of sulfur of about 0.01 wt. % to about 0.70 wt. %, 0.01 to 0.6 wt. %, 0.01 to 0.5 wt. %, 0.01 to 0.4 wt. %, 0.01 to 0.3 wt. %, 0.01 to 0.2 wt. %, 0.01 wt. % to 0.10 wt. %. In one embodiment, the level of sulfur in the lubricating oil compositions of the present invention is less than or equal to about 0.60 wt. %, less than or equal to about 0.50 wt. %, less than or equal to about 0.40 wt. %, less than or equal to about 0.30 wt. %, less than or equal to about 0.20 wt. %, less than or equal to about 0.10 wt. % based on the total weight of the lubricating oil composition.

In one embodiment, the levels of phosphorus in the lubricating oil compositions of the present invention is less than or equal to about 0.12 wt. %, based on the total weight of the lubricating oil composition, e.g., a level of phosphorus of about 0.01 wt. % to about 0.12 wt. %. In one embodiment, the levels of phosphorus in the lubricating oil compositions of the present invention is less than or equal to about 0.11 wt. %, based on the total weight of the lubricating oil composition, e.g., a level of phosphorus of about 0.01 wt. % to about 0.11 wt. %. In one embodiment, the levels of phosphorus in the lubricating oil compositions of the present invention is less than or equal to about 0.10 wt. %, based on the total weight of the lubricating oil composition, e.g., a level of phosphorus of about 0.01 wt. % to about 0.10 wt. %. In one embodiment, the levels of phosphorus in the lubricating oil compositions of the present invention is less than or equal to about 0.09 wt. %, based on the total weight of the lubricating oil composition, e.g., a level of phosphorus of about 0.01 wt. % to about 0.09 wt. %. In one embodiment, the levels of phosphorus in the lubricating oil compositions of the present invention is less than or equal to about 0.08 wt. %, based on the total weight of the lubricating oil composition, e.g., a level of phosphorus of about 0.01 wt. % to about 0.08 wt. %. In one embodiment, the levels of phosphorus in the lubricating oil compositions of the present invention is less than or equal to about 0.07 wt. %, based on the total weight of the lubricating oil composition, e.g., a level of phosphorus of about 0.01 wt. % to about 0.07 wt. %. In one embodiment, the levels of phosphorus in the lubricating oil compositions of the present invention is less than or equal to about 0.05 wt. %, based on the total weight of the lubricating oil composition, e.g., a level of phosphorus of about 0.01 wt. % to about 0.05 wt. %. In one embodiment, the lubricating oil is substantially free of phosphorus.

In one embodiment, the level of sulfated ash produced by the lubricating oil compositions of the present invention is less than or equal to about 1.60 wt. % as determined by ASTM D 874, e.g., a level of sulfated ash of from about 0.10 to about 1.60 wt. % as determined by ASTM D 874. In one embodiment, the level of sulfated ash produced by the lubricating oil compositions of the present invention is less than or equal to about 1.00 wt. % as determined by ASTM D 874, e.g., a level of sulfated ash of from about 0.10 to about 1.00 wt. % as determined by ASTM D 874. In one embodiment, the level of sulfated ash produced by the lubricating oil compositions of the present invention is less than or equal to about 0.80 wt. % as determined by ASTM D 874, e.g., a level of sulfated ash of from about 0.10 to about 0.80 wt. % as determined by ASTM D 874. In one embodiment, the level of sulfated ash produced by the lubricating oil compositions of the present invention is less than or equal to about 0.60 wt. % as determined by ASTM D 874, e.g., a level of sulfated ash of from about 0.10 to about 0.60 wt. % as determined by ASTM D 874.

All ASTM standards referred to herein are the most current versions as of the filing date of the present application.

In an aspect, provided is a passenger car internal combustion engine lubricating oil additive composition comprising:
(a) a major amount of a base oil of lubricating viscosity, said base oil having a kinematic viscosity (Kv) at 100° C. of about 2.0 to about 12 centistokes (cSt);
(b) a nitrogen-containing dispersant;
(c) an alkaline earth metal containing detergent providing from about 0.03 to about 0.7 wt. % based on the metal content to the lubricating oil composition;
(d) about 0.01 wt. % to about 2.0 wt. % of a compound comprising the reaction product of:
   (i) a nitrogen-containing reactant, wherein the nitrogen-containing reactant comprises an alkyl alkanolamide, an alkyl alkoxylated alkanolamide, an alkyl alkanolamine, an alkyl alkoxylated alkanolamine or mixtures thereof,
   (ii) a source of boron, and
   (iii) a hydrocarbyl polyol, having at least three hydroxyl groups.

Also provided is a method for improving fresh oil and used oil fuel economy in a passenger car internal combustion engine comprising lubricating said engine with a lubricating oil composition comprising:
(a) a major amount of a base oil of lubricating viscosity, said base oil having a kinematic viscosity (Kv) at 100° C. of about 2.0 to about 12 centistokes (cSt);
(b) a nitrogen-containing dispersant;
(c) an alkaline earth metal containing detergent providing from about 0.03 to about 0.7 wt. % based on the metal content to the lubricating oil composition;
(d) about 0.01 wt. % to about 2.0 wt. % of a compound comprising the reaction product of:
   (i) a nitrogen-containing reactant, wherein the nitrogen-containing reactant comprises an alkyl alkanolamide, an alkyl alkoxylated alkanolamide, an alkyl alkanolamine, an alkyl alkoxylated alkanolamine or mixtures thereof,
   (ii) a source of boron, and
   (iii) a hydrocarbyl polyol, having at least three hydroxyl groups.

In an aspect, provided is a heavy-duty diesel engine lubricating oil additive composition comprising:
(a) a major amount of a base oil of lubricating viscosity, said base oil having a kinematic viscosity (Kv) at 100° C. of about 2.0 to about 12 centistokes (cSt);
(b) a nitrogen-containing dispersant;
(c) an alkaline earth metal containing detergent providing from about 0.03 to about 0.7 wt. % based on the metal content to the lubricating oil composition;
(d) greater than 0.30 wt. % to about 2.0 wt. % of a compound comprising the reaction product of:
   (i) a nitrogen-containing reactant, wherein the nitrogen-containing reactant comprises an alkyl alkanolamide, an alkyl alkoxylated alkanolamide, an alkyl alkanolamine, an alkyl alkoxylated alkanolamine or mixtures thereof,
   (ii) a source of boron, and
   (iii) a hydrocarbyl polyol, having at least three hydroxyl groups.

Also provided is a method for improving fresh oil and used oil fuel economy in a heavy-duty diesel engine comprising lubricating said engine with a lubricating oil composition comprising:
(a) a major amount of a base oil of lubricating viscosity, said base oil having a kinematic viscosity (Kv) at 100° C. of about 2.0 to about 12 centistokes (cSt);
(b) a nitrogen-containing dispersant;
(c) an alkaline earth metal containing detergent providing from about 0.03 to about 0.7 wt. % based on the metal content to the lubricating oil composition;
(d) greater than 0.30 wt. % to about 2.0 wt. % of a compound comprising the reaction product of:
   (i) a nitrogen-containing reactant, wherein the nitrogen-containing reactant comprises an alkyl alkanolamide, an alkyl alkoxylated alkanolamide, an alkyl alkanolamine, an alkyl alkoxylated alkanolamine or mixtures thereof,
   (ii) a source of boron, and
   (iii) a hydrocarbyl polyol, having at least three hydroxyl groups.

In certain embodiments, the present disclosure provides lubricating oil compositions suitable for reducing friction in passenger car internal combustion engines, particularly spark-ignited, direct injection and/or port fuel injection engines. In certain embodiments, the engine may be coupled to an electric motor/battery system in a hybrid vehicle (e.g., a port fuel injection spark ignition engine coupled to an electric motor/battery system in a hybrid vehicle). In certain embodiments, the present disclosure provides lubricating oil compositions suitable for reducing friction in heavy-duty diesel internal combustion engines.

### The Nitrogen-Containing Reactant

Alkanolamides

In one embodiment, the nitrogen-containing reactant is an alkyl di-alkanolamide. Such alkyl di-alkanolamides include, but are not limited to, di-ethanolamides derived from coconut oil. Typically, the alkyl group in coconut oil comprises mixtures of caprylyl, capryl, lauryl, myristyl, palmityl stearyl, oleyl and linoleyl.

Typically, alkyl di-alkanolamides are prepared by reacting carboxylic acids and esters with di-alkanolamines. Alkyl di-alkanolamides may be prepared from individual C₂-C₃₀ carboxylic acids—such as myristoleic acid, palmitoleic acid, oleic acid, linolenic acid, caproic acid, caprylic acid, capric acid, lauric acid, myristic acid, palmitic acid, stearic acid, arachidic acid, behenic acid, lignoceric acid, and the like—or their methyl esters as, for example, decanoic, lauric, myristic, palmitic, stearic, and oleic, or mixtures of alkyls such as those derived from animal fats or vegetable oils, that is, tallow, coconut oil, palm oil, palm kernel oil, fish oils, etc. These can readily be reacted with a variety of dialkanolamines to produce the desired alkyl di-alkanolamides. The alkyl di-alkanolamides may be prepared according to methods that are well known in the art, including, but not limited to, the process described in U.S. Pat. Nos. 4,085,126; 4,116,986; and 8,901,328, the disclosures of which are incorporated herein by reference.

In one embodiment, the nitrogen-containing reactant is an alkyl di-alkanolamide having the following formula (I):

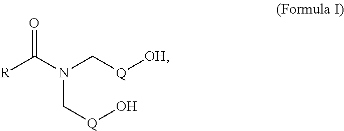

where R comprises 1 to 30 carbon atoms; preferably wherein R comprises 6 to 22 carbon atoms; more preferably, where R comprises from about 8 to about 18 carbon atoms and where Q is a C₁ to C₄ linear or branched alkylene group. In one embodiment, R comprises 17 carbon atoms. In another embodiment, R comprises 11 carbon atoms.

In one embodiment, the di-alkanolamide comprises a bis-ethoxy alkylamide. For example, the bis-ethoxy alkylamide has the following formula (II):

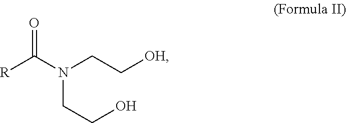

where R comprises 1 to 30 carbon atoms; preferably where R comprises 6 to 22 carbon atoms; more preferably, where R comprises from about 8 to about 18 carbon atoms. In one embodiment, R comprises 17 carbon atoms. In another embodiment, R comprises 11 carbon atoms.

Alkanolamines

In one embodiment, the nitrogen-containing reactant is an alkyl di-alkanolamine. Such alkyl di-alkanolamines include, but are not limited to, di-ethanolamines derived from coconut oil. Typically, the alkyl group in coconut oil comprises mixtures of caprylyl, capryl, lauryl, myristyl, palmityl stearyl, oleyl and linoleyl.

In one embodiment, the nitrogen-containing reactant is an alkyl di-alkanolamine having the following formula (III):

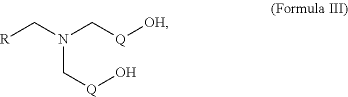

where R comprises 1 to 30 carbon atoms; preferably wherein R comprises 6 to 22 carbon atoms; more preferably, where R comprises from about 8 to about 18 carbon atoms and where Q is a C₁ to C₄ linear or branched alkylene group. In one embodiment, R comprises 17 carbon atoms. In another embodiment, R comprises 11 carbon atoms.

In one embodiment, the di-alkanolamine comprises a bis-ethoxy alkylamine. For example, the bis-ethoxy alkylamine has the following formula (IV):

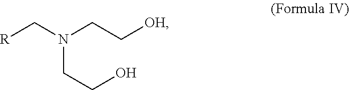

where R comprises 1 to 30 carbon atoms; preferably where R comprises 6 to 22 carbon atoms; more preferably, where R comprises from about 8 to about 18 carbon atoms. In one embodiment, R comprises 17 carbon atoms. In another embodiment, R comprises 11 carbon atoms.

The alkyl group of the di-alkanolamides and di-alkanolamines can have varying levels of unsaturation. For example, the alkyl group can comprise double and triple bonds.

Typically, alkyl di-alkanolamines are commercially available from Akzo Nobel. For example, products sold under the tradename Ethomeen® C/12 or Ethomeen® O/12 are suitable di-alkanolamines for use in the present invention.

Examples of alkyl alkanolamines include but are not limited to the following: Oleyl diethanolamine, dodecyl diethanolamine, 2-ethylhexyl diethanolamine, diethanolamine derived from coconut oil and diethanolamine derived from beef tallow and the like.

### Alkoxylated Alkyl Alkanolamides

In one embodiment, the nitrogen-containing reactant is an alkoxylated alkyl alkanolamide. The alkoxylated moiety may be ethoxylated, propoxylated, butoxylated and the like.

The alkyl moiety of the alkoxylated alkyl alkanolamide is preferably a branched or straight chain, alkyl or alkenyl group containing 3 to 21 carbon atoms, more preferably containing 8 to 18 carbon atoms, or combinations thereof. The alkoxy moiety may be an ethoxy, propoxy, or butoxy group, or combinations thereof. In a preferred embodiment propoxylated alkyl alkanolamides, more preferably propoxylated alkyl ethanolamides are employed.

Alkoxylated alkyl alkanolamides represented by the following formula (V):

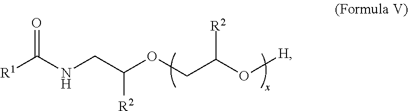

where R¹ is a branched or straight chain, saturated or unsaturated C₃-C₂₁ alkyl radical, preferably a C₈-C₁₈ alkyl radical, or a combination thereof; R₂ is a hydrogen, or C₁-C₂ alkyl radical or a combination thereof, preferably R₂ is either hydrogen or a C₁ alkyl radical; x is from about 1 to about 8, preferably about 1 to about 5, and more preferably from about 1 to about 3.

Examples of useful alkoxylated-alkyl alkanolamides include polyoxypropylene-, polyoxybutylene-, alkyl ethanolamides or alkyl isopropanolamides. Alkoxylated alkyl ethanolamides are preferred, particularly propoxylated alkyl ethanolamides. The alkyl ethanolamide moiety is preferably an alkyl monoethanolamide, and more preferably is derived from lauric monoethanolamide, capric monoethanolamide, caprylic monoethanolamide, caprylic/capric monoethanolamide, decanoic monoethanolamide, myristic monoethanolamide, palmitic monoethanolamide, stearic monoethanolamide, isostearic monoethanolamide, oleic monoethanolamide, linoleic monoethanolamide, octyidecanoic monoethanolamide, 2-heptylundecanoic monoethanolamide, alkyl monoethanolamide derived from coconut oil, alkyl monoethanolamide derived from beef tallow, alkyl monoethanolamide derived from soy bean oil and alkyl monoethanolamide derived from palm kernel oil. Of these capryl, linoleyl, stearic, isostearic, and those derived from soy bean oil or coconut oil are preferred.

Preferred propoxylated fatty ethanolamides include propoxylated hydroxyethyl caprylamides, propoxylated hydroxyethyl cocamides, propoxylated hydroxyethyl linoleamides, propoxylated hydroxyethyl isostearamides, and combinations thereof. Propoxylated hydroxyethyl cocamides are more preferred. Preferred specific materials are PPG-1 hydroxyethyl caprylamide, PPG-2 hydroxyethyl cocamide, PPG-3 hydroxyethyl linoleamide, PPG-2 hydroxyethyl isostearamide, and combinations thereof. PPG-2 hydroxyethyl cocamide is particularly preferred.

In an alternative embodiment, alkoxylated alkyl isopropanolamides are employed. The alkyl isopropanolamide moiety is preferably an alkyl monoisopropanolamide, and more preferably is derived from lauric monoisopropanolamide, capric monoisopropanolamide, caprylic monoisopropanolamide, caprylic/capric monoisopropanolamide, decanoic monoisopropanolamide, myristic monoisopropanolamide, palmitic monoisopropanolamide, stearic monoisopropanolamide, isostearic monoisopropanolamide, oleic monoisopropanolamide, linoleic monoisopropanolamide, octyldecanoic monoisopropanolamide, 2-heptylundecanoic monoisopropanolamide, alkyl monoisopropanolamide derived from coconut oil, alkyl monoisopropanolamide derived from beef tallow, monoisopropanolamide derived from soy bean oil, and alkyl monoisopropanolamide derived from palm kernel oil.

Alkoxylated alkyl dialkanolamides represented by the following formula (VI):

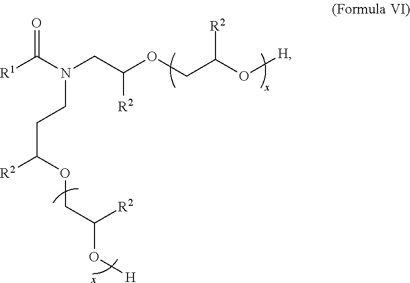

where R¹ is a branched or straight chain, saturated or unsaturated C₃-C₂₁ alkyl radical, preferably a C₈-C₁₈ alkyl radical, or a combination thereof; R² is a hydrogen or a C₁-C₂ alkyl radical or a combination thereof, preferably R² is a hydrogen or a C₁ alkyl radical; x is from about 1 to about 8, preferably about 1 to about 5, and more preferably from about 1 to about 3.

Examples of useful alkoxylated-alkyl dialkanolamides include polyoxypropylene-, polyoxybutylene-, alkyl diethanolamides or alkyl diisopropanolamides. Alkoxylated alkyl diethanolamides are preferred, particularly propoxylated alkyl diethanolamides. The alkyl diethanolamide moiety is preferably an alkyl diethanolamide, and more preferably is derived from lauric diethanolamide, capric diethanolamide, caprylic diethanolamide, caprylic/capric diethanolamide, decanoic diethanolamide, myristic diethanolamide, palmitic diethanolamide, stearic diethanolamide, isostearic diethanolamide, oleic diethanolamide, linoleic diethanolamide, octyidecanoic diethanolamide, 2-heptylundecanoic diethanolamide, alkyl diethanolamide derived from coconut oil, alkyl diethanolamide derived from beef tallow, alkyl diethanolamide derived from soy bean oil and alkyl diethanolamide derived from palm kernel oil. Of these capryl, linoleyl, stearic, isostearic, and those derived from soy bean oil or coconut oil are preferred.

Preferred propoxylated fatty diethanolamide include propoxylated bisethoxy caprylamides, propoxylated bisethoxy cocamides, propoxylated bisethoxy linoleamides, propoxylated bisethoxy isostearamides, and combinations thereof. Propoxylated bisethoxy cocamides are more preferred. Preferred specific materials are PPG-1 bisethoxy caprylamide, PPG-2 bisethoxy cocamide, PPG-3 bisethoxy linoleamide, PPG-2 bisethoxy isostearamide, and combinations thereof. PPG-2 bisethoxy cocamide is particularly preferred.

In an alternative embodiment, alkoxylated alkyl diisopropanolamides are employed. The alkyl isopropanolamide moiety is preferably an alkyl diisopropanolamide, and more preferably is derived from lauric diisopropanolamide, capric diisopropanolamide, caprylic diisopropanolamide, caprylic/capric diisopropanolamide, decanoic diisopropanolamide, myristic diisopropanolamide, palmitic diisopropanolamide, stearic diisopropanolamide, isostearic diisopropanolamide, oleic diisopropanolamide, linoleic diisopropanolamide, octyldecanoic diisopropanolamide, 2-heptylundecanoic diisopropanolamide, alkyl diisopropanolamide derived from coconut oil, alkyl diisopropanolamide derived from beef tallow, diisopropanolamide derived from soy bean oil, and alkyl diisopropanolamide derived from palm kernel oil.

### Alkoxylated Alkyl Alkanolamines

In one embodiment, the nitrogen-containing reactant is an alkyl alkanolamine having one of the following formula (VII or VIII):

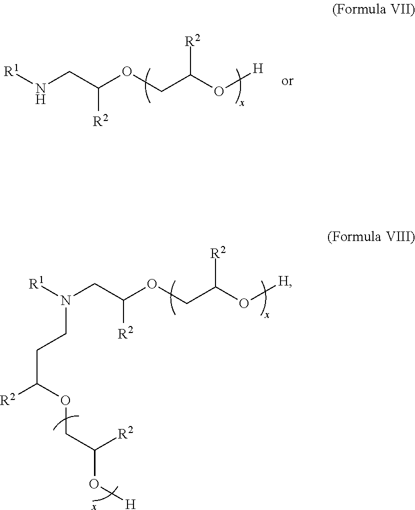

where R¹ is a branched or straight chain, saturated or unsaturated C₃-C₂₁ alkyl radical, preferably a C₈-C₁₈ alkyl radical, or a combination thereof; R² is a hydrogen or a C₁-C₂ alkyl radical or a combination thereof, preferably R² is a hydrogen or a C₁ alkyl radical; x is from about 1 to about 8, preferably about 1 to about 5, and more preferably from about 1 to about 3.

In one embodiment, the nitrogen-containing reactant is an alkyl monoalkanolamine or an alkyl dialkanolamine. Such alkyl monoalkanolamine and alkyl dialkanolamine include, but are not limited to, monoethanolamine derived from coconut oil or cocomonoethanolamine, diethanolamine derived from coconut oil, lauric myristic diethanolamine, lauric monoethanolamine, lauric diethanolamine and lauric monoisopropanolamine. Typically, the alkyl group in coconut oil comprises mixtures of caprylic, capric, lauric, myristic, palmitic, stearic, oleic and linoleic

Typically, alkyl monoalkanolamines and alkyl dialkanolamines are commercially available from Akzo Nobel.

Examples of alkyl alkanolamines include but are not limited to the following:

Oleyl diethanolamine, diethanolamine derived from coconut oil and diethanolamine derived from beef tallow and the like.

Examples of useful alkoxylated-alkyl dialkanolamines include polyoxypropylene-, polyoxybutylene-, alkyl diethanolamines or alkyl diisopropanolamines. Alkoxylated alkyl diethanolamines are preferred, particularly propoxylated alkyl diethanolamines. The alkyl diethanolamine moiety is preferably an alkyl diethanolamine, and more preferably is derived from lauric diethanolamine, capric diethanolamine, caprylic diethanolamine, caprylic/capric diethanolamine, decanoic diethanolamine, myristic diethanolamine, palmitic diethanolamine, stearic diethanolamine, isostearic diethanolamine, oleic diethanolamine, linoleic diethanolamine, octyidecanoic diethanolamine, 2-heptylundecanoic diethanolamine, alkyl diethanolamine derived from coconut oil, alkyl diethanolamine derived from beef tallow, alkyl diethanolamine derived from soy bean oil and alkyl diethanolamine derived from palm kernel oil. Of these capryl, linoleyl, stearic, isostearic, and those derived from soy bean oil or coconut oil are preferred.

Preferred propoxylated fatty diethanolamine include propoxylated bisethoxy caprylamines, propoxylated bisethoxy cocamines, propoxylated bisethoxy linoleamines, propoxylated bisethoxy isostearamines, and combinations thereof. Propoxylated bisethoxy cocamines are more preferred. Preferred specific materials are PPG-1 bisethoxy caprylamine, PPG-2 bisethoxy cocamine, PPG-3 bisethoxy linoleamine, PPG-2 bisethoxy isostearamine, and combinations thereof. PPG-2 bisethoxy cocamine is particularly preferred.

In an alternative embodiment, alkoxylated alkyl diisopropanolamines are employed. The alkyl isopropanolamine moiety is preferably an alkyl diisopropanolamine, and more preferably is derived from lauric diisopropanolamine, capric diisopropanolamine, caprylic diisopropanolamine, caprylic/capric diisopropanolamine, decanoic diisopropanolamine, myristic diisopropanolamine, palmitic diisopropanolamine, stearic diisopropanolamine, isostearic diisopropanolamine, oleic diisopropanolamine, linoleic diisopropanolamine, octyldecanoic diisopropanolamine, 2-heptylundecanoic diisopropanolamine, alkyl diisopropanolamine derived from coconut oil, alkyl diisopropanolamine derived from beef tallow, diisopropanolamine derived from soy bean oil, and alkyl diisopropanolamine derived from palm kernel oil.

The nitrogen-containing reactant may be prepared by methods that are well known in the art. Alkyl alkanolamides and alkyl alkanolamines may be prepared according to U.S. Pat. Nos. 4,085,126; 7,479,473 and other methods that are well known in the art; or, they may be purchased from Akzo Nobel.

### Source of Boron

Suitable boron compounds include boron trioxide or any of the various forms of boric acid including metaboric acid (HBO₂), orthoboric acid (H₃BO₃) and tetraboric acid (H₂B₄O₂). Alkyl borates such as the mono-, di- and tri-C₁₋₆ alkyl borates may employ. Thus, suitable alkyl borates are the mono-, di- and tri-methylborates; the mono-, di- and tri-ethylborates; the mono-, di- and tri-propylborates, and the mono-, di- and tri-butylborates and mixtures thereof. The particularly preferred boron compound is boric acid and especially orthoboric acid. These may be pwthased from suppliers such as Aldrich or Fisher Scientific.

### Hydrocarbyl Polyol Reactant

In one embodiment, the hydrocarbyl polyol reactant includes hydrocarbyl polyol components and its derivatives, excluding esters, has at least three hydroxyl groups. More preferred, the hydrocarbyl polyol component has the following formula (IX):

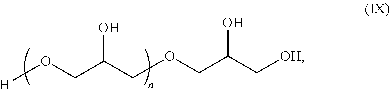

wherein n is 0 or an integer from 1 to 5. Preferably, n is 0 or 1.

Examples of hydrocarbyl polyols that may be employed in the present invention include the compounds of the following formula (X) and (XI):

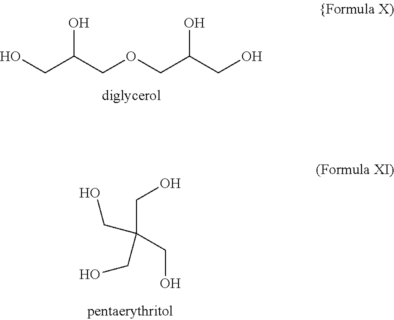 [SMILES: OCC(O)COCC(O)CO ; OCC(CO)(CO)CO]

Method of Making the Lubricating Oil Additive Composition

The lubricating oil additive composition is prepared by charging a vessel with a nitrogen-containing reactant along with an aromatic solvent. Preferably, the nitrogen-reactant is bis-ethoxy alkylamine (which is also known as alkyl diethanolamine) or bis-ethoxy alkylamide. A source of boron, such as boric acid, is then added to the vessel. The mixture is refluxed until the water has been substantially removed to drive the reaction to completion and then an hydrocarbyl polyol having at least three hydroxyl groups, such as glycerol or pentaerythritol, is added to the mixture.

In one embodiment, the hydrocarbyl polyol having at least three hydroxyl groups is added to the vessel at the same time as the source of boron. The mixture is then refluxed for two hours.

Preferably the ratio of the nitrogen-containing reactant, the source of boron reactant and glycerol is from about 1:0.2:0.2 to 1:2.5:2.5. More preferred, the ratio is from about 1:0.2:0.2 to 1:1.5:1.5. Even more preferred, the ratio is from about 1:0.4:0.4 to 1:1:1. Most preferred, the ratio is from about 1:0.5:0.5 to 1:0.75:0.75.

### Oil of Lubricating Viscosity

The oil of lubricating viscosity (sometimes referred to as “base stock” or “base oil”) is the primary liquid constituent of a lubricant, into which additives and possibly other oils are blended, for example to produce a final lubricant (or lubricant composition). A base oil is useful for making concentrates as well as for making lubricating oil compositions therefrom, and may be selected from natural and synthetic lubricating oils and combinations thereof.

Natural oils include animal and vegetable oils, liquid petroleum oils and hydrorefined, solvent-treated mineral lubricating oils of the paraffinic, naphthenic and mixed paraffinic-naphthenic types. Oils of lubricating viscosity derived from coal or shale are also useful base oils.

Synthetic lubricating oils include hydrocarbon oils such as polymerized and interpolymerized olefins (e.g., polybutylenes, polypropylenes, propylene-isobutylene copolymers, chlorinated polybutylenes, poly(1-hexenes), poly(1-octenes), poly(1-decenes); alkylbenzenes (e.g., dodecylbenzenes, tetradecylbenzenes, dinonylbenzenes, di(2-ethylhexyl)benzenes, Alkylated Naphthalene; polyphenols (e.g., biphenyls, terphenyls, alkylated polyphenols); and alkylated diphenyl ethers and alkylated diphenyl sulfides and the derivatives, analogues and homologues thereof.

Another suitable class of synthetic lubricating oils comprises the esters of dicarboxylic acids (e.g., malonic acid, alkyl malonic acids, alkenyl malonic acids, succinic acid, alkyl succinic acids and alkenyl succinic acids, maleic acid, fumaric acid, azelaic acid, suberic acid, sebacic acid, adipic acid, linoleic acid dimer, phthalic acid) with a variety of alcohols (e.g., butyl alcohol, hexyl alcohol, dodecyl alcohol, 2-ethylhexyl alcohol, ethylene glycol, diethylene glycol monoether, propylene glycol). Specific examples of these esters include dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, and the complex ester formed by reacting one mole of sebacic acid with two moles of tetraethylene glycol and two moles of 2-ethylhexanoic acid.

Esters useful as synthetic oils also include those made from C₅ to C₁₂ monocarboxylic acids and polyols, and polyol ethers such as neopentyl glycol, trimethylolpropane, pentaerythritol, dipentaerythritol and tripentaerythritol.

The base oil may be derived from Fischer-Tropsch synthesized hydrocarbons. Fischer-Tropsch synthesized hydrocarbons are made from synthesis gas containing H₂ and CO using a Fischer-Tropsch catalyst. Such hydrocarbons typically require further processing in order to be useful as the base oil. For example, the hydrocarbons may be hydroisomerized; hydrocracked and hydroisomerized; dewaxed; or hydroisomerized and dewaxed; using processes known to those skilled in the art.

Unrefined, refined and re-refined oils can be used in the present lubricating oil composition. Unrefined oils are those obtained directly from a natural or synthetic source without further purification treatment. For example, a shale oil obtained directly from retorting operations, a petroleum oil obtained directly from distillation or ester oil obtained directly from an esterification process and used without further treatment would be unrefined oil. Refined oils are similar to the unrefined oils except they have been further treated in one or more purification steps to improve one or more properties. Many such purification techniques, such as distillation, solvent extraction, acid or base extraction, filtration and percolation are known to those skilled in the art.

Re-refined oils are obtained by processes similar to those used to obtain refined oils applied to refined oils which have been already used in service. Such re-refined oils are also known as reclaimed or reprocessed oils and often are additionally processed by techniques for approval of spent additive and oil breakdown products.

Hence, the base oil which may be used to make the present lubricating oil composition may be selected from any of the base oils in Groups I-V as specified in the American Petroleum Institute (API) Base Oil Interchangeability Guidelines (API Publication 1509). Such base oil groups are summarized in Table 1 below:

TABLE 1

| | Base Oil Properties | | |
|---|---|---|---|
| Group^{(a)} | Saturates^{(b)}, wt. % | Sulfur^{(c)}, wt. % | Viscosity Index^{(d)} |
| Group I | <90 and/or | >0.03 | 80 to <120 |
| Group II | ≥90 | ≤0.03 | 80 to <120 |
| Group III | ≥90 | ≤0.03 | ≥120 |

| | |
|---|---|
| Group IV | Polyalphaolefins (PAOs) |
| Group V | All other base stocks not included in Groups I, II, III or IV |

^{(a)}Groups I-III are mineral oil base stocks.
^{(b)}Determined in accordance with ASTM D2007.
^{(c)}Determined in accordance with ASTM D2622, ASTM D3120, ASTM D4294 or ASTM D4927.
^{(d)}Determined in accordance with ASTM D2270.

Base oils suitable tor use herein are any of the variety corresponding to API Group II, Group III, Group IV, and Group V oils and combinations thereof, preferably the Group III to Group V oils due to their exceptional volatility, stability, viscometric and cleanliness features.

The oil of lubricating viscosity for use in the lubricating oil compositions of this disclosure, also referred to as a base oil, is typically present in a major amount, e.g., an amount of greater than 50 wt. %, preferably greater than about 70 wt. %, more preferably from about 80 to about 99.5 wt. % and most preferably from about 85 to about 98 wt. %, based on the total weight of the composition. The expression “base oil” as used herein shall be understood to mean a base stock or blend of base stocks which is a lubricant component that is produced by a single manufacturer to the same specifications (independent of feed source or manufacturer's location); that meets the same manufacturer's specification; and that is identified by a unique formula, product identification number, or both. The base oil for use herein can be any presently known or later-discovered oil of lubricating viscosity used in formulating lubricating oil compositions for any and all such applications, e.g., engine oils, marine cylinder oils, functional fluids such as hydraulic oils, gear oils, transmission fluids, etc. Additionally, the base oils for use herein can optionally contain viscosity index improvers, e.g., polymeric alkylmethacrylates; olefinic copolymers, e.g., an ethylene-propylene copolymer or a styrene-butadiene copolymer; and the like and mixtures thereof. The topology of viscosity modifier could include, but is not limited to, linear, branched, hyperbranched, star, or comb topology.

As one skilled in the art would readily appreciate, the viscosity of the base oil is dependent upon the application. Accordingly, the viscosity of a base oil for use herein will ordinarily range from about 2 to about 2000 centistokes (cSt) at 100° Centigrade (C.). Generally, individually the base oils used as engine oils will have a kinematic viscosity range at 100° C. of about 2 cSt to about 30 cSt, preferably about 3 cSt to about 16 cSt, and most preferably about 4 cSt to about 12 cSt and will be selected or blended depending on the desired end use and the additives in the finished oil to give the desired grade of engine oil, e.g., a lubricating oil composition having an SAE Viscosity Grade of 0W, 0W-8, 0W-12, 0W-16, 0W-20, 0W-26, 0W-30, 0W-40, 0W-50, 0W-60, 5W, 5W-20, 5W-30, 5W-40, 5W-50, 5W-60, 10W, 10W-20, 10W-30, 10W-40, 10W-50, 15W, 15W-20, 15W-30, 15W-40, 30, 40 and the like.

The lubricating oil composition has a viscosity index of at least 135 (e.g., 135 to 400, or 135 to 250), at least 150 (e.g., 150 to 400, 150 to 250), at least 165 (e.g., 165 to 400, or 165 to 250), at least 190 (e.g., 190 to 400, or 190 to 250), or at least 200 (e.g., 200 to 400, or 200 to 250). If the viscosity index of the lubricating oil composition is less than 135, it may be difficult to improve fuel efficiency while maintaining the HTHS viscosity at 150° C. If the viscosity index of the lubricating oil composition exceeds 400, evaporation properties may be reduced, and deficits due to insufficient solubility of the additive and matching properties with a seal material may be caused.

The lubricating oil composition has a high temperature shear (HTHS) viscosity at 150° C. of 3.5 cP or less (e.g., 1.0 to 3.5 cP), 3.3 cP or less (e.g., 1.0 to 3.3 cP), 3.0 cP or less (e.g., 1.3 to 3.0 cP), 2.6 cP or less (e.g., 1.3 to 2.6 cP), 2.3 cP or less (e.g., 1.0 to 2.3 cP, or 1.3 to 2.3 cP), such as 2.0 cP or less (e.g., 1.0 to 2.0 cP, or 1.3 to 2.0 cP), or even 1.7 cP or less (e.g., 1.0 to 1.7 cP, or 1.3 to 1.7 cP).

The lubricating oil composition has a kinematic viscosity at 100° C. in a range of 3 to 12 mm²/s (e.g., 3 to 6.9 mm²/s, 3.5 to 6.9 mm²/s, or 4 to 6.9 mm²/s).

Suitably, the present lubricating oil composition may have a total base number (TBN) of 4 to 15 mg KOH/g (e.g., 5 to 12 mg KOH/g, 6 to 12 mg KOH/g, or 8 to 12 mg KOH/g).

In an embodiment, the lubricating oil composition of the present disclosure can further comprise an organomolybdenum compound.

Organomolybdenum Compound

The organomolybdenum compound contains at least molybdenum, carbon and hydrogen atoms, but may also contain sulfur, phosphorus, nitrogen and/or oxygen atoms. Suitable organomolybdenum compounds include molybdenum dithiocarbamates, molybdenum dithiophosphates, and various organic molybdenum complexes such as molybdenum carboxylates, molybdenum esters, molybdenum amines, molybdenum amides, which can be obtained by reacting molybdenum oxide or ammonium molybdates with fats, glycerides or fatty acids, or fatty acid derivatives (e.g., esters, amines, amides). The term “fatty” means a carbon chain having 10 to 22 carbon atoms, typically a straight carbon chain.

Molybdenum dithiocarbamate (MoDTC) is an organomolybdenum compound represented by the following formula (XII):

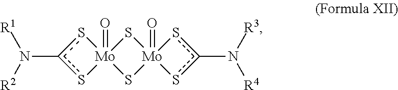

where R¹, R², R³ and R⁴ are independently of each other, linear or branched alkyl groups having from 4 to 18 carbon atoms (e.g., 8 to 13 carbon atoms).
Molybdenum dithiophosphate (MoDTP) is an organomolybdenum compound represented by the following formula (XIII):

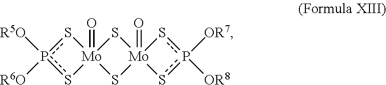

where R⁵, R⁶, R⁷ and R⁸ are independently of each other, linear or branched alkyl groups having from 4 to 18 carbon atoms (e.g., 8 to 13 carbon atoms).
In one embodiment, the molybdenum amine is a molybdenum-succinimide complex. Suitable molybdenum-succinimide complexes are described, for example, in U.S. Pat. No. 8,076,275. These complexes are prepared by a process comprising reacting an acidic molybdenum compound with an alkyl or alkenyl succinimide of a polyamine of formulas (XIV) or (XV) or mixtures thereof:

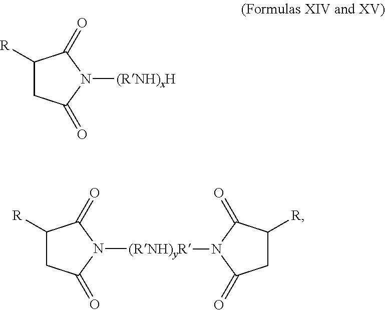

where R is a C₂₄ to C₃₅₀ (e.g., C₇₀ to C₁₂₈) alkyl or alkenyl group; R′ is a straight or branched-chain alkylene group having 2 to 3 carbon atoms; xis 1 to 11; and y is 1 to 10. The molybdenum compounds used to prepare the molybdenum-succinimide complex are acidic molybdenum compounds or salts of acidic molybdenum compounds. By “acidic” is meant that the molybdenum compounds will react with a basic nitrogen compound as measured by ASTM D664 or D2896. Generally, the acidic molybdenum compounds are hexavalent. Representative examples of suitable molybdenum compounds include molybdenum trioxide, molybdic acid, ammonium molybdate, sodium molybdate, potassium molybdate and other alkaline metal molybdates and other molybdenum salts such as hydrogen salts, (e.g., hydrogen sodium molybdate), MoOCl₄, MoO₂Br₂, Mo₂O₃Cl₆, and the like.

The succinimides that can be used to prepare the molybdenum-succinimide complex are disclosed in numerous references and are well known in the art. Certain fundamental types of succinimides and the related materials encompassed by the term of art “succinimide” are taught in U.S. Pat. Nos. 3,172,892; 3,219,666; and 3,272,746. The term “succinimide” is understood in the art to include many of the amide, imide, and amidine species which may also be formed. The predominant product however is a succinimide and this term has been generally accepted as meaning the product of a reaction of an alkyl or alkenyl substituted succinic acid or anhydride with a nitrogen-containing compound. Preferred succinimides are those prepared by reacting a polyisobutenyl succinic anhydride of about 70 to 128 carbon atoms with a polyalkylene polyamine selected from triethylenetetramine, tetraethylenepentamine, and mixtures thereof.

The molybdenum-succinimide complex may be post-treated with a sulfur source at a suitable pressure and a temperature not to exceed 120° C. to provide a sulfurized molybdenum-succinimide complex. The sulfurization step may be carried out for a period of from about 0.5 to 5 hours (e.g., 0.5 to 2 hours). Suitable sources of sulfur include elemental sulfur, hydrogen sulfide, phosphorus pentasulfide, organic polysulfides of formula R₂Sₓ where R is hydrocarbyl (e.g., C₁ to C₁₀ alkyl) and x is at least 3, C₁ to C₁₀ mercaptans, inorganic sulfides and polysulfides, thioacetamide, and thiourea.

The molybdenum-succinimide complex is used in an amount that provides at least 50 ppm (e.g., 50 to 1500 ppm), at least 100 ppm, (e.g., 100 to 1500 ppm), at least 200 ppm (e.g., 200 to 1500 ppm, 200 to 1100 ppm, 250 to 1500 ppm, 250 to 1100 ppm, or 300 to 1000 ppm) by weight of molybdenum to the lubricating oil composition.

In an embodiment, the lubricating oil composition of the present disclosure can further comprise an antiwear agent. In certain embodiments, the antiwear agent can be a Zinc dithiophosphate (ZnDTP) compound.

Antiwear Agent

The lubricating oil composition disclosed herein can comprise an anti-wear agent that can reduce friction and excessive wear. Non-limiting examples of suitable anti-wear agents include zinc dithiophosphate, metal (e.g., Pb, Sb, Mo and the like) salts of dithiophosphate, metal (e.g., Zn, Pb, Sb, Mo and the like) salts of dithiocarbamate, metal (e.g., Zn, Pb, Sb and the like) salts of fatty acids, boron compounds, phosphate esters, phosphite esters, amine salts of phosphoric acid esters or thiophosphoric acid esters, reaction products of dicyclopentadiene and thiophosphoric acids and combinations thereof. The amount of the anti-wear agent may vary from about 0.01 wt. % to about 5 wt. %, from about 0.05 wt. % to about 3 wt. %, or from about 0.1 wt. % to about 1 wt. %, based on the total weight of the lubricating oil composition.

In certain embodiments, the anti-wear agent comprises a dihydrocarbyl dithiophosphate metal salt, such as zinc dialkyl dithiophosphate compounds. The metal of the dihydrocarbyl dithiophosphate metal salt may be an alkali or alkaline earth metal, or aluminum, lead, tin, molybdenum, manganese, nickel or copper. In some embodiments, the metal is zinc. In other embodiments, the alkyl group of the dihydrocarbyl dithiophosphate metal salt has from about 3 to about 22 carbon atoms, from about 3 to about 18 carbon atoms, from about 3 to about 12 carbon atoms, or from about 3 to about 8 carbon atoms. In further embodiments, the alkyl group is linear or branched.

The amount of the dihydrocarbyl dithiophosphate metal salt including the zinc dialkyl dithiophosphate salts in the lubricating oil composition disclosed herein is measured by its phosphosphorus content. In some embodiments, the phosphosphorus content of the lubricating oil composition disclosed herein is from about 0.01 wt. % to about 0.12 wt. %, from about 0.01 wt. % to about 0.10 wt. %, from about 0.01 wt. % to about 0.08 wt. %, from about 0.01 wt. % to about 0.05 wt. %, or less than 0.08 wt. % based on the total weight of the lubricating oil composition.

In certain embodiments, the lubricating oil composition is substantially free of phosphorous. In certain embodiments, the lubricating oil composition is substantially free of zinc containing compounds.

The dihydrocarbyl dithiophosphate metal salt may be prepared in accordance with known techniques by first forming a dihydrocarbyl dithiophosphoric acid (DDPA), usually by reacting one or more of alcohols and phenolic compounds with P₂S₅ and then neutralizing the formed DDPA with a compound of the metal, such as an oxide, hydroxide or carbonate of the metal. In some embodiments, a DDPA may be made by reacting mixtures of primary and secondary alcohols with P₂S₅. In other embodiments, two or more dihydrocarbyl dithiophosphoric acids can be prepared where the hydrocarbyl groups on one are entirely secondary in character and the hydrocarbyl groups on the others are entirely primary in character. The zinc salts can be prepared from the dihydrocarbyl dithiophosphoric acids by reacting with a zinc compound. In some embodiments, a basic or a neutral zinc compound is used. In other embodiments, an oxide, hydroxide or carbonate of zinc is used.

In some embodiments, oil soluble zinc dialkyl dithiophosphates may be produced from dialkyl dithiophosphoric acids represented by formula (XVI):

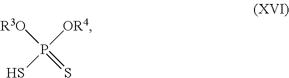

wherein each of R³ and R⁴ is independently linear or branched alkyl or linear or branched substituted alkyl. In some embodiments, the alkyl group has from about 3 to about 30 carbon atoms or from about 3 to about 8 carbon atoms.

The dialkyldithiophosphoric acids of formula (XVI) can be prepared by reacting alcohols R³OH and R⁴OH with P₂S₅ where R³ and R⁴ are as defined above. In some embodiments, R³ and R⁴ are the same. In other embodiments, R³ and R⁴ are different. In further embodiments, R³OH and R⁴OH react with P₂S₅ simultaneously. In still further embodiments, R³OH and R⁴OH react with P₂S₅ sequentially.

Mixtures of hydroxyl alkyl compounds may also be used. These hydroxyl alkyl compounds need not be monohydroxy alkyl compounds. In some embodiments, the dialkyldithiophosphoric acids is prepared from mono-, di-, tri-, tetra-, and other polyhydroxy alkyl compounds, or mixtures of two or more of the foregoing. In other embodiments, the zinc dialkyldithiophosphate derived from only primary alkyl alcohols is derived from a single primary alcohol. In further embodiments, that single primary alcohol is 2-ethylhexanol. In certain embodiments, the zinc dialkyldithiophosphate derived from only secondary alkyl alcohols. In further embodiments, that mixture of secondary alcohols is a mixture of 2-butanol and 4-methyl-2-pentanol.

The phosphorus pentasulfide reactant used in the dialkyldithiophosphoric acid formation step may contain certain amounts of one or more of P₂S₃, P₄S₃, P₄S₇, or P₄S₉. Compositions as such may also contain minor amounts of free sulfur. In certain embodiments, the phosphorus pentasulfide reactant is substantially free of any of P₂S₃, P₄S₃, P₄S₇, and P₄S₉. In certain embodiments, the phosphorus pentasulfide reactant is substantially free of free sulfur.

In certain embodiments, the lubricating oil composition comprises a Zinc dithiophosphate (ZnDTP) compound. In certain embodiments, the ZnDTP is selected from the group consisting of a primary ZnDTP, a secondary ZnDTP, or combinations thereof.

Detergent Mixture

The detergent mixture comprises at least one calcium-containing detergent and optionally, at least one magnesium-containing detergent.

A typical detergent is an anionic material that contains a long chain hydrophobic portion of the molecule and a smaller anionic or oleophobic hydrophilic portion of the molecule. The anionic portion of the detergent is typically derived from an organic acid such as a sulfur acid, carboxylic acid, phosphorous acid, phenol, or mixtures thereof. The counterion is typically an alkaline earth or alkali metal.

Salts that contain a substantially stoichiometric amount of the metal are described as neutral salts and have a total base number (TBN) of from 0 to 80 mg KOH/g. Many compositions are overbased, containing large amounts of a metal base that is achieved by reacting an excess of a metal compound (e.g., a metal hydroxide or oxide) rich an acidic gas (e.g., carbon dioxide). Useful detergents can be neutral, mildly overbased, or highly overbased.

It is desirable for at least some detergent used in the detergent mixture to be overbased. Overbased detergents help neutralize acidic impurities produced by the combustion process and become entrapped in the oil. Typically, the overbased material has a ratio of metallic ion to anionic portion of the detergent of 1.05:1 to 50:1 (e.g., 4:1 to 25:1) on an equivalent basis. The resulting detergent is an overbased detergent that will typically have a TBN of 150 mg KOH/g or higher (e.g., 250 to 450 mg KOH/g or more). A mixture of detergents of differing TBN can be used.

Suitable detergents include metal salts of sulfonates, phenates, carboxylates, phosphates, and salicylates.

Sulfonates may be prepared from sulfonic acids which are typically obtained by the sulfonation of alkyl-substituted aromatic hydrocarbons such as those obtained from the fractionation of petroleum or by the alkylation of aromatic hydrocarbons. Examples included those obtained by alkylating benzene, toluene, xylene, naphthalene, diphenyl or their halogen derivatives. The alkylation may be carried out in the presence of a catalyst with alkylating agents having from about 3 to more than 70 carbon atoms. The alkaryl sulfonates usually contain from about 9 to 80 or more carbon atoms (e.g., about 16 to 60 carbon atoms) per alkyl substituted aromatic moiety.

Phenates can be prepared by reacting an alkaline earth metal hydroxide or oxide (e.g., CaO, Ca(OH)₂, MgO, or Mg(OH)₂) with an alkyl phenol or sulfurized alkylphenol. Useful alkyl groups include straight or branched chain C₁ to C₃₀ (e.g., C₄ to C₂₀) alkyl groups, or mixtures thereof. Examples of suitable phenols include isobutylphenol, 2-ethylhexylphenol, nonylphenol, dodecyl phenol, and the like. It should be noted that starting alkylphenols may contain more than one alkyl substituent that are each independently straight chain or branched chain. When a non-sulfurized alkylphenol is used, the sulfurized product may be obtained by methods well known in the art. These methods include heating a mixture of alkylphenol and sulfurizing agent (e.g., elemental sulfur, sulfur halides such as sulfur dichloride, and the like) and then reacting the sulfurized phenol with an alkaline earth metal base.

Salicylates may be prepared by reacting a basic metal compound with at least one carboxylic acid and removing water from the reaction product. Detergents made from salicylic acid are one class of detergents prepared from carboxylic acids. Useful salicylates include long chain alkyl salicylates. One useful family of compositions is of the following formula (XVI):

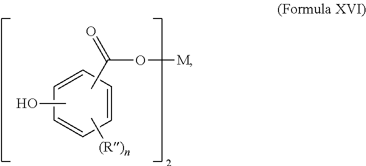

wherein R″ is a C₁ to C₃₀ (e.g., C₁₃ to C₃₀) alkyl group; n is an integer from 1 to 4; and M is an alkaline earth metal (e.g., Ca or Mg).

Hydrocarbyl-substituted salicylic acids may be prepared from phenols by the Kolbe reaction (see U.S. Pat. No. 3,595,791). The metal salts of the hydrocarbyl-substituted salicylic acids may be prepared by double decomposition of a metal salt in a polar solvent such as water or alcohol.

Alkaline earth metal phosphates are also used as detergents and are known in the art.

Preferred calcium-containing detergents include calcium sulfonates, calcium phenates, and calcium salicylates, especially calcium sulfonates, calcium salicylates, and mixtures thereof.

Preferred magnesium-containing detergents include magnesium sulfonates, magnesium phenates, and magnesium salicylates, especially magnesium sulfonates.

Viscosity Modifier

Viscosity modifiers function to impart high and low temperature operability to a lubricating oil. The viscosity modifier used may have that sole function, or may be multifunctional. Multifunctional viscosity modifiers that also function as dispersants are also known. Suitable viscosity modifiers include polyisobutylene, copolymers of ethylene and propylene and higher alpha-olefins, polymethacrylates, polyalkylmethacrylates, methacrylate copolymers, copolymers of an unsaturated dicarboxylic acid and a vinyl compound, interpolymers of styrene and acrylic esters, and partially hydrogenated copolymers of styrene/isoprene, styrene/butadiene, and isoprene/butadiene, as well as the partially hydrogenated homopolymers of butadiene and isoprene and isoprene/divinylbenzene. In one embodiment, the viscosity modifier is a polyalkylmethacrylate. The topology of the viscosity modifier could include, but is not limited to, linear, branched, hyperbranched, star, or comb topology. The viscosity modifier can be non-dispersant type or dispersant type. In one embodiment, the viscosity modifier is a dispersant polymethacrylate.

Suitable viscosity modifiers have a Permanent Shear Stability Index (PSSI) of 30 or less (e.g., 10 or less, 5 or less, or even 2 or less). PSSI is a measure of the irreversible decrease, resulting from shear, in an oil's viscosity contributed by an additive. PSSI is determined according to ASTM D6022. The lubricating oil compositions of the present disclosure display stay-in-grade capability. Retention of kinematic viscosity at 100° C. within a single SAE viscosity grade classification by a fresh oil and its sheared version is evidence of an oil's stay-in-grade capability.

The viscosity modifier may be used in an amount of from 0.5 to 15.0 wt. % (e.g., 0.5 to 10 wt. %, 0.5 to 5 wt. %, 1.0 to 15 wt. %, 1.0 to 10 wt. %, or 1.0 to 5 wt. %), based on the total weight of the lubricating oil composition.

### Additional Lubricating Oil Additives

The lubricating oil compositions of the present disclosure may also contain other conventional additives that can impart or improve any desirable property of the lubricating oil composition in which these additives are dispersed or dissolved. Any additive known to a person of ordinary skill in the art may be used in the lubricating oil compositions disclosed herein. Some suitable additives have been described in Mortier et al., “Chemistry and Technology of Lubricants”, 2nd Edition, London, Springer, (1996); and Leslie R. Rudnick, “Lubricant Additives: Chemistry and Applications”, New York, Marcel Dekker (2003), both of which are incorporated herein by reference. For example, the lubricating oil compositions can be blended with antioxidants, rust inhibitors, dehazing agents, demulsifying agents, metal deactivating agents, friction modifiers, pour point depressants, antifoaming agents, co-solvents, corrosion-inhibitors, ashless dispersants, multifunctional agents, dyes, extreme pressure agents and the like and mixtures thereof. A variety of the additives are known and commercially available. These additives, or their analogous compounds, can be employed for the preparation of the lubricating oil compositions of the disclosure by the usual blending procedures.

In the preparation of lubricating oil formulations, it is common practice to introduce the additives in the form of 10 to 80 wt. % active ingredient concentrates in hydrocarbon oil, e.g. mineral lubricating oil, or other suitable solvent.

Usually these concentrates may be diluted with 3 to 100, e.g., 5 to 40, parts by weight of lubricating oil per part by weight of the additive package in forming finished lubricants, e.g. crankcase motor oils. The purpose of concentrates, of course, is to make the handling of the various materials less difficult and awkward as well as to facilitate solution or dispersion in the final blend.

Each of the foregoing additives, when used, is used at a functionally effective amount to impart the desired properties to the lubricant. Thus, for example, if an additive is a friction modifier, a functionally effective amount of this friction modifier would be an amount sufficient to impart the desired friction modifying characteristics to the lubricant.

In general, the concentration of each of the additives in the lubricating oil composition, when used, may range from about 0.001 wt. % to about 20 wt. %, from about 0.01 wt. % to about 15 wt. %, or from about 0.1 wt. % to about 10 wt. %, from about 0.005 wt. % to about 5 wt. %, or from about 0.1 wt. % to about 2.5 wt. %, based on the total weight of the lubricating oil composition. Further, the total amount of the additives in the lubricating oil composition may range from about 0.001 wt. % to about 20 wt. %, from about 0.01 wt. % to about 10 wt. %, or from about 0.1 wt. % to about 5 wt. %, based on the total weight of the lubricating oil composition.

The internal combustion engine may or may not have an exhaust gas recirculation system. The internal combustion engine may be fitted with an emission control system or a turbocharger. Examples of the emission control system include diesel particulate filters (DPF), Gasoline Particulate Filters (GPF), Three-Way Catalyst (TWC) or systems employing selective catalytic reduction (SCR).

In one embodiment, the internal combustion engine may be a diesel fueled engine (typically a heavy-duty diesel engine), a gasoline fueled engine, a natural gas fueled engine, a mixed gasoline/alcohol fueled engine, or a hydrogen fueled internal combustion engine. In one embodiment, the internal combustion engine may be a diesel fueled engine and in another embodiment a gasoline fueled engine. In one embodiment, the internal combustion engine may be a heavy-duty diesel engine. In one embodiment, the internal combustion engine may be a gasoline engine such as a gasoline direct injection engine (GDI engines). GDI engines generate high levels of soot which cause corrosive wear. The organic type friction modifiers of the present disclosure show excellent friction reduction performance relative to other types of friction modifiers such as MDOT.

The following examples are presented to exemplify embodiments of the disclosure but are not intended to limit the disclosure to the specific embodiments set forth. Unless indicated to the contrary, all parts and percentages are by weight. All numerical values are approximate. When numerical ranges are given, it should be understood that embodiments outside the stated ranges may still fall within the scope of the disclosure. Specific details described in each example should not be construed as necessary features of the disclosure.

It will be understood that various modifications may be made to the embodiments disclosed herein. Therefore, the above description should not be construed as limiting, but merely as exemplifications of preferred embodiments. For example, the functions described above and implemented as the best mode for operating the present disclosure are for illustration purposes only. Other arrangements and methods may be implemented by those skilled in the art without departing from the scope and spirit of this disclosure. Moreover, those skilled in the art will envision other modifications within the scope and spirit of the claims appended hereto.

### EXAMPLES

The following examples are intended for illustrative purposes only and do not limit in any way the scope of the present disclosure.

### Example A

Example A is a mixed Borate Ester of Bis-Ethoxy Cocamide with Glycerol was prepared according to Example 3 of U.S. Pat. No. 9,371,499.

### Comparative Example A

Comparative Example A is a molybdenum dithiocarbamate (SAKURA-LUBE® 515; ADEKA Corporation).

### Comparative Example B

Comparative Example B is a borated glycerol monooleate friction modifier.

### Baseline 1

A heavy-duty lubricating oil composition was prepared that contained a major amount of a base oil of lubricating viscosity and the following additives, to provide a finished oil having a HTHS viscosity at 150° C. of 3.3 cP (5W-30):
(1) an ethylene carbonate post-treated bis-succinimide;
(2) a borated bis-succinimide dispersant;
(3) succinate ester dispersant;
(4) 2870 ppm in terms of calcium content of a mixture of overbased calcium salicylate and sulfonate detergents;
(5) 400 ppm in terms of phosphorus content, of a secondary zinc dialkyldithiophosphate;
(6) 220 ppm of a sulfurized molybdenum succinimide complex;
(7) an alkylated diphenylamine and hindered phenol antioxidant;
(8) a dispersed hydrated potassium borate
(9) a foam inhibitor;
(10) a non-dispersant OCP VII; and
(11) the remainder, a Group III base oil.

### Example 1

To formulation baseline 1 was added 0.6 wt % of the friction modifier of Example A.

### Comparative Example 1

To formulation baseline 1 was added 0.6 wt % of the friction modifier of Comparative Example A.

### Example 2

To formulation baseline 1 was added 0.3 wt % of the friction modifier of Example A.

### Baseline 2

A heavy-duty lubricating oil composition was prepared that contained a major amount of a base oil of lubricating viscosity and the following additives, to provide a finished oil having a HTHS viscosity at 150° C. of 3.2 cP (5W-30):
(1) an ethylene carbonate post-treated bis-succinimide;
(2) a borated bis-succinimide dispersant;
(3) 2730 ppm in terms of calcium content of a mixture of overbased calcium salicylate, phenate, and sulfonate detergents;
(4) 400 ppm in terms of phosphorus content, of a primary zinc dialkyldithiophosphate;
(5) 160 ppm of a sulfurized molybdenum succinimide complex;
(6) an alkylated diphenylamine antioxidant;
(7) a dispersed hydrated potassium borate;
(8) a foam inhibitor;
(9) a non-dispersant OCP VII; and
(10) the remainder, a Group III base oil.

### Example 3

To formulation baseline 2 was added 0.6 wt % of the friction modifier of Example A.

### Example 4

To formulation baseline 1 was added 0.6 wt % of the friction modifier of Example A.

### Example 5

To formulation baseline 1 was added 0.6 wt % of the friction modifier of Example A.

### Example 6

To formulation baseline 2 was added 0.6 wt % of the friction modifier of Example A.

### JASO DH-2F Fuel Economy Test

The JASO DH-2F Fuel Economy Test was conducted according to the procedure disclosed JASO M362, summarized in Hashimoto, K., Tomizawa, K., Nakamura, Y., Hashimoto, T. et al., “The Development of Fuel Economy Test Method for Heavy-duty Diesel Engine Oil (The First HD Engine Test Method and the New JASO DH-2F Category),” SAE Int. J. Fuels Lubr. 10(2):2017.

The criterion of (JASO M 355:2017) application manual for average of fresh oil ([Fresh 60° C.+Fresh 90° C.]/2) was set to greater than 3.7% for fuel economy diesel engine oil and for sum of average fresh and average aged oil was set to greater than 6.8% fuel economy improvement.

TABLE 2
Heavy-duty Fresh Oil Fuel Economy

| | Fresh | Fresh | Fresh |
|---|---|---|---|
| | 60° C., % | 90° C., % | Avg., % |
| Baseline 1 | 4.70 | 2.14 | 3.42 |
| Example 1 | 5.03 | 2.72 | 3.85 |
| Comparative | 4.72 | 2.50 | 3.61 |
| Example 1 | | | |
| Example 2 | 4.90 | 2.68 | 3.79 |
| Baseline 2 | 4.38 | 2.44 | 3.41 |
| Example 3 | 5.52 | 2.71 | 4.11 |

TABLE 3
Heavy-duty Used Oil Fuel Economy

| | | | | Sum of Fresh |
|---|---|---|---|---|
| | Used | Used | Used | Avg. and |
| | 60° C., % | 90° C., % | Avg., % | Used Avg. |
| Example 4 | 3.77 | 2.22 | 2.99 | 6.84 |

### Baseline 3

A passenger car lubricating oil composition was prepared that contained a major amount of a base oil of lubricating viscosity and the following additives, to provide a finished oil having an SAE viscosity of 0W-8:
(1) an ethylene carbonate post-treated bis-succinimide;
(2) a borated bis-succinimide dispersant;
(3) a mixture of calcium salicylate and magnesium sulfonate detergents providing the formulation with 1410 ppm Ca and 470 ppm Mg;
(4) 770 ppm in terms of phosphorus content, of a primary zinc dialkyldithiophosphate;
(5) 800 ppm of MoDTC;
(6) an alkylated diphenylamine and hindered phenol antioxidant;
(7) a foam inhibitor;
(8) a low SSI PMA VII; and
(9) the remainder, a Group III base oil.

### Example 7

To formulation baseline 3 was added 0.20 wt % of the friction modifier of Example A.

Baseline 4

A passenger car lubricating oil composition was prepared that contained a major amount of a base oil of lubricating viscosity and the following additives, to provide a finished oil having an SAE viscosity of 0W-8:
(1) an ethylene carbonate post-treated bis-succinimide;
(2) a borated bis-succinimide dispersant;
(3) a mixture of calcium salicylate and magnesium sulfonate detergents providing the formulation with 1410 ppm Ca and 470 ppm Mg;
(4) 770 ppm in terms of phosphorus content of a secondary zinc dialkyldithiophosphate;
(5) 800 ppm of MoDTC;
(6) an alkylated diphenylamine and hindered phenol antioxidant;
(7) a foam inhibitor;
(8) a low SSI PMA VII; and
(9) the remainder, a Group III base oil.

### Example 8

To formulation baseline 4 was added 0.20 wt % of the friction modifier of Example A.

### Example 9

To formulation baseline 4 was added 0.10 wt % of the friction modifier of Example A.

### Example 10

To formulation baseline 4 was added 0.50 wt % of the friction modifier of Example A.

### Example 11

To formulation baseline 4 was added 0.10 wt % of the friction modifier of Example A and instead of 800 ppm of molybdenum from MoDTC was added 800 ppm of molybdenum from a sulfurized molybdenum succinimide complex.

### Example 12

To formulation baseline 4 was added 0.20 wt % of the friction modifier of Example A and instead of 800 ppm of molybdenum from MoDTC was added 800 ppm of molybdenum from a sulfurized molybdenum succinimide complex.

### Example 13

To formulation baseline 4 was added 0.50 wt % of the friction modifier of Example A and instead of 800 ppm of molybdenum from MoDTC was added 800 ppm of molybdenum from a sulfurized molybdenum succinimide complex.

### Example 14

To formulation baseline 4 was added 0.10 wt % of the friction modifier of Example A and instead of 800 ppm of molybdenum from MoDTC was added 400 ppm of molybdenum from a sulfurized molybdenum succinimide complex and 400 ppm of molybdenum from MoDTC.

### Example 15

To formulation baseline 4 was added 0.20 wt % of the friction modifier of Example A and instead of 800 ppm of molybdenum from MoDTC was added 400 ppm of molybdenum from a sulfurized molybdenum succinimide complex and 400 ppm of molybdenum from MoDTC.

### Example 16

To formulation baseline 4 was added 0.50 wt % of the friction modifier of Example A and instead of 800 ppm of molybdenum from MoDTC was added 400 ppm of molybdenum from a sulfurized molybdenum succinimide complex and 400 ppm of molybdenum from MoDTC.

### Example 17

To formulation baseline 4 was added 0.05 wt % of the friction modifier of Example A.

### Example 18

To formulation baseline 4 was added 0.01 wt % of the friction modifier of Example A.

### High Frequency Reciprocating Rig (HFRR)

The HFRR test rig is an industry recognized tribometer for determining lubricant performance. The PCS instrument uses an electromagnetic vibrator to oscillate a specimen (the ball) over a small amplitude while pressing it against a fixed specimen (a flat disk). The amplitude and frequency of the oscillation and the load are variable. The frictional force between the ball and flat and the electrical contact resistance (ECR) are measured. The flat, stationary specimen is held in a bath to which the lubricating oil is added, and can be heated. For this test, the tribometer was set up to run at 20 Hz, using 6 mm ball on flat specimens of 52100 steel. The load was 400 g and temperature was conducted at 70° C. In this test, a smaller coefficient of friction corresponds to a more effective lubricating friction modifier additive. The HFRR friction performance data are represented in Table 4.

TABLE 4

| | Friction | Friction |
|---|---|---|
| | Coefficient, | Coefficient, |
| | 70° C., | 70° C., |
| | first 5 min | last 5 min |
| Baseline 3 | 0.136 | 0.073 |
| Example 7 | 0.131 | 0.071 |
| Baseline 4 | 0.145 | 0.067 |
| Example 8 | 0.100 | 0.071 |
| Example 9 | 0.131 | 0.060 |
| Example 10 | 0.132 | 0.058 |
| Example 11 | 0.126 | 0.060 |
| Example 12 | 0.137 | 0.087 |
| Example 13 | 0.130 | 0.077 |
| Example 14 | 0.131 | 0.062 |
| Example 15 | 0.129 | 0.061 |
| Example 16 | 0.131 | 0.061 |
| Example 17 | 0.133 | 0.059 |
| Example 18 | 0.136 | 0.059 |

It is evident that Examples 7-18 therefore clearly provide improved friction performance.

### Baseline 5

A passenger car lubricating oil composition was prepared that contained a major amount of a base oil of lubricating viscosity and the following additives, to provide a finished oil which is free of ZnDTP having an SAE viscosity of 5W-20 and has a sulfated ash of 0.15 wt. %:
(1) an ethylene carbonate post-treated bis-succinimide;
(2) a borated bis-succinimide dispersant;
(3) 400 ppm of calcium from an overbased calcium phenate detergent;
(5) 180 ppm of Mo from a sulfurized molybdenum succinimide complex;
(6) an alkylated diphenylamine antioxidant;
(7) a foam inhibitor;
(8) an OCP VII; and
(9) the remainder, a Group II base oil.

### Example 19

To formulation baseline 5 was added 0.5 wt % of the friction modifier of Example A.

### Comparative Example 2

To formulation baseline 5 was added 0.3 wt % of the friction modifier of Comparative Example B.

### Baseline 6

A passenger car lubricating oil composition was prepared that contained a major amount of a base oil of lubricating viscosity and the following additives, to provide a finished oil having an SAE viscosity of 5W-20 and has a sulfated ash of 0.40 wt. %:
(1) an ethylene carbonate post-treated bis-succinimide;
(2) a borated bis-succinimide dispersant;
(3) 400 ppm of calcium from an overbased calcium phenate detergent;
(4) 770 ppm of phosphorus of a secondary ZnDTP;
(5) 180 ppm of Mo from a sulfurized molybdenum succinimide complex;
(6) an alkylated diphenylamine antioxidant;
(7) a foam inhibitor;
(8) an OCP VII; and
(9) the remainder, a Group II base oil.

### Example 20

To formulation baseline 6 was added 0.5 wt % of the friction modifier of Example A.

### Comparative Example 2

To formulation baseline 6 was added 0.3 wt % of the friction modifier of Comparative Example B.

### Baseline 7

A passenger car lubricating oil composition was prepared that contained a major amount of a base oil of lubricating viscosity and the following additives, to provide a finished oil having an SAE viscosity of 5W-20 and has a sulfated ash of 1.0 wt. %:
(1) an ethylene carbonate post-treated bis-succinimide;
(2) a borated bis-succinimide dispersant;
(3) 2190 ppm of calcium from an overbased calcium phenate and calcium salicylate detergents;
(4) 770 ppm of phosphorus of a secondary ZnDTP;
(5) 180 ppm of Mo from a sulfurized molybdenum succinimide complex;
(6) an alkylated diphenylamine antioxidant;
(7) a foam inhibitor;
(8) an OCP VII; and
(9) the remainder, a Group II base oil.

### Example 18

To formulation baseline 7 was added 0.5 wt % of the friction modifier of Example A.

### Comparative Example 3

To formulation baseline 7 was added 0.3 wt % of the friction modifier of Comparative Example B.

### Mini-Traction Machine (MTM)

The compositions described above were tested for friction performance in a MTM bench test. The MTM is manufactured by PCS Instruments and operates with a ball (0.75 inches in diameter 8620 steel ball) loaded against a rotating disk (52100 steel). The conditions employ a load of approximately 10-30 Newtons, a speed of approximately 10-2000 mm/s and a temperature of approximately 125-150° C. In this bench test, friction performance is measured as the total area under the second Stribeck curve generated. Lower total area values correspond to better friction performance. Results are given in Table 5.

TABLE 5

| | MTM Result (Area under |
|---|---|
| | Stribeck Curve) |
| Baseline 4 | 114.6 |
| Example 16 | 45.0 |
| Comparative | 103.7 |
| Example 1 | |
| Baseline 5 | 183.0 |
| Example 17 | 79.2 |
| Comparative | 146.0 |
| Example 2 | |
| Baseline 6 | 176.7 |
| Example 18 | 109.3 |
| Comparative | 132.6 |
| Example 3 | |

The data in Table 5 clearly show that the examples of the present disclosure provide reduced friction and therefore improved fuel economy in internal combustion engines.

1. A passenger car internal combustion engine lubricating oil composition comprising:
(a) a major amount of a base oil of lubricating viscosity, said base oil having a kinematic viscosity (Kv) at 100° C. of about 2.0 to about 12 centistokes (cSt);
(b) a nitrogen-containing dispersant;
(c) an alkaline earth metal non-borated containing detergent providing from about 0.03 to about 0.7 wt. % based on the metal content to the lubricating oil composition;
(d) about 0.01 wt. % to about 2.0 wt. % of a compound comprising the reaction product of:
(i) a nitrogen-containing reactant, wherein the nitrogen-containing reactant comprises an alkyl alkanolamide, an alkyl alkoxylated alkanolamide, an alkyl alkanolamine, an alkyl alkoxylated alkanolamine or mixtures thereof,
(ii) a source of boron, and
(iii) a hydrocarbyl polyol, having at least three hydroxyl groups.

2. The lubricating oil composition of claim 1, wherein the nitrogen-containing reactant is an alkyl alkanolamide, an alkyl alkoxylated alkanolamide, an alkyl alkanolamine, an alkyl alkoxylated alkanolamine or mixtures thereof comprises a bis-ethoxy alkylamine or a bis-ethoxy alkylamide.

3. The lubricating oil composition of claim 2, wherein the alkyl group in the bis-ethoxy alkylamine comprises oleyl, dodecyl, or 2-ethylhexyl.

4. The lubricating oil composition of claim 2, wherein the alkyl group in the bis-ethoxy alkylamide is derived from coconut oil.

5. The lubricating oil composition of claim 1, wherein the source of boron is boric acid.

6. The lubricating oil composition of claim 1, wherein the hydrocarbyl polyol comprises glycerol or pentaerythritol.

7. The lubricating oil composition of claim 1, wherein the lubricating oil composition has a HTHS viscosity at 150° C. in a range of about 1.3 to about 3.5 cP.

8. The lubricating oil composition of claim 1, wherein the alkaline earth metal detergent is selected from the group consisting of a calcium or magnesium containing salicylate, carboxylate, phenate, sulfonate, or combination thereof.

9. The lubricating oil composition of claim 1, wherein the lubricating oil composition further comprises a organomolybdenum compound.

10. The lubricating oil composition of claim 1, further comprising a ZnDTP compound.

11. The lubricating oil composition of claim 1, wherein the phosphorus content of the lubricating oil composition is less than 0.08 wt. %.

12. The lubricating oil composition of claim 1, wherein the lubricating oil composition has a sulfated ash level of less than 1.6 wt. %.

13. A method for improving fresh oil or used oil fuel economy in a passenger car internal combustion engine comprising lubricating said engine with a lubricating oil composition comprising:
(a) a major amount of a base oil of lubricating viscosity, said base oil having a kinematic viscosity (Kv) at 100° C. of about 2.0 to about 12 centistokes (cSt);
(b) a nitrogen-containing dispersant;
(c) an alkaline earth metal non-borated containing detergent providing from about 0.03 to about 0.7 wt. % based on the metal content to the lubricating oil composition;
(d) about 0.01 wt. % to about 2.0 wt. % of a compound comprising the reaction product of:
(i) a nitrogen-containing reactant, wherein the nitrogen-containing reactant comprises an alkyl alkanolamide, an alkyl alkoxylated alkanolamide, an alkyl alkanolamine, an alkyl alkoxylated alkanolamine or mixtures thereof,
(ii) a source of boron, and
(iii) a hydrocarbyl polyol, having at least three hydroxyl groups.

14. The method of claim 13 wherein the internal combustion engine is selected from a direct injection spark ignition engine and a port fuel injection spark ignition engine coupled to an electric motor/battery system in a hybrid vehicle.

15. The method of claim 13, wherein engine is equipped with a gasoline particulate filter.

16. A heavy-duty diesel internal combustion engine lubricating oil additive composition comprising:
(a) a major amount of a base oil of lubricating viscosity, said base oil having a kinematic viscosity (Kv) at 100° C. of about 2.0 to about 12 centistokes (cSt);
(b) a nitrogen-containing dispersant;
(c) an alkaline earth metal non-borated containing detergent providing from about 0.03 to about 0.7 wt. % based on the metal content to the lubricating oil composition;
(d) greater than 0.30 wt. % to about 2.0 wt. % of a compound comprising the reaction product of:
(i) a nitrogen-containing reactant, wherein the nitrogen-containing reactant comprises an alkyl alkanolamide, an alkyl alkoxylated alkanolamide, an alkyl alkanolamine, an alkyl alkoxylated alkanolamine or mixtures thereof,
(ii) a source of boron, and
(iii) a hydrocarbyl polyol, having at least three hydroxyl groups.

17. The lubricating oil composition of claim 16, wherein the nitrogen-containing reactant is an alkyl alkanolamide, an alkyl alkoxylated alkanolamide, an alkyl alkanolamine, an alkyl alkoxylated alkanolamine or mixtures thereof comprises a bis-ethoxy alkylamine or a bis-ethoxy alkylamide.

18. The lubricating oil composition of claim 17, wherein the alkyl group in the bis-ethoxy alkyl amine comprises oleyl, dodecyl, or 2-ethylhexyl.

19. The lubricating oil composition of claim 17, wherein the alkyl group in the bis-ethoxy alkyl amide is derived from coconut oil.

20. The lubricating oil composition of claim 16, wherein the source of boron is boric acid.

21. The lubricating oil composition of claim 16, wherein the hydrocarbyl polyol comprises glycerol or pentaerythritol.

22. The lubricating oil composition of claim 16, wherein the lubricating oil composition has a HTHS viscosity at 150° C. in a range of about 2.5 to about 3.5 cP.

23. The lubricating oil composition of claim 16, wherein the alkaline earth metal detergent is selected from the group consisting of a calcium or magnesium containing salicylate, carboxylate, phenate, sulfonate, or combination thereof.

24. The lubricating oil composition of claim 16, wherein the lubricating oil composition further comprises a organomolybdenum compound.

25. The lubricating oil composition of claim 16, further comprising a ZnDTP compound.

26. The lubricating oil composition of claim 16, wherein the phosphorus content of the lubricating oil composition is less than 0.08 wt. %.

27. The lubricating oil composition of claim 16, wherein the lubricating oil composition is substantially free of phosphorus containing additives.

28. The lubricating oil composition of claim 16, wherein the lubricating oil composition is substantially free of zinc containing additives.

29. The lubricating oil composition of claim 16, wherein the lubricating oil composition has a sulfated ash level of less than 1.6 wt. %.

30. A method for improving fresh oil or used oil fuel fuel economy in a heavy-duty diesel internal combustion engine comprising lubricating said engine with a lubricating oil additive composition comprising:
(a) a major amount of a base oil of lubricating viscosity, said base oil having a kinematic viscosity (Kv) at 100° C. of about 2.0 to about 12 centistokes (cSt);
(b) a nitrogen-containing dispersant;
(c) an alkaline earth metal non-borated containing detergent providing from about 0.03 to about 0.7 wt. % based on the metal content to the lubricating oil composition;
(d) greater than 0.30 wt. % to about 2.0 wt. % of a compound comprising the reaction product of:
(i) a nitrogen-containing reactant, wherein the nitrogen-containing reactant comprises an alkyl alkanolamide, an alkyl alkoxylated alkanolamide, an alkyl alkanolamine, an alkyl alkoxylated alkanolamine or mixtures thereof,
(ii) a source of boron, and
(iii) a hydrocarbyl polyol, having at least three hydroxyl groups.

31. The method of claim 30, wherein the engine is equipped with a diesel particulate filter.
